(19) United States
(12) Patent Application Publication
(10) Pub. No.: US 2019/0308848 A1
(43) Pub. Date: Oct. 10, 2019

(54) SCISSOR LIFT ELEVATOR PLATFORM

(71) Applicant: Otis Elevator Company, Farmington, CT (US)

(72) Inventor: Kenneth P. Litteral, Florence, SC (US)

(21) Appl. No.: 15/949,582

(22) Filed: Apr. 10, 2018

(51) Int. Cl. B66B 11/02; B66F 3/22; B66B 9/00; B66B 5/00

(52) U.S. Cl. CPC B66B 11/0246; B66F 3/22; B66B 5/0056; B66B 5/005; B66B 5/0087; B66B 9/00

(57) ABSTRACT

An elevator car includes a car body having a car floor, one or more car sidewalls, and a car ceiling. A movable floor panel is located at the car floor. The movable floor panel is configured to be moved between a stowed position and a raised position, such that access to an elevator system hoistway is gained via the movable floor panel in the raised positon. A method of performing maintenance on an elevator system component includes moving an elevator car along a hoistway to a maintenance position, raising a movable floor panel of the elevator car from a stowed position to a raised position, accessing an elevator system component located in the hoistway outside of the elevator car through an opening in the elevator car via the movable floor panel located in the raised position, and performing maintenance on the component from inside of the elevator car.

### BACKGROUND

Exemplary embodiments pertain to the art of elevator systems. More particularly, the present disclosure relates to inspection and maintenance of elevator system components.

In current, typical elevator systems, technicians or maintenance personnel often enter the hoistway above or underneath of the elevator car to access elevator system components in the hoistway or to perform maintenance in the hoistway, by entering the hoistway through a hoistway door. In order to protect the mechanics or technicians, etc., during those operations, codes and/or regulations have specified a safety volume and clearance for technicians entering the hoistway resulting in a larger overall volume of the elevator systems. Elevator system customers, however, desire that the elevator system occupy a smaller overall volume. Thus, new elevator systems are being developed in which many maintenance activities can be performed from inside the car, alleviating the need to provide such a safety volume in the pit and/or at a top of the hoistway.

### BRIEF DESCRIPTION

In one embodiment, an elevator car includes a car body having a car floor, one or more car sidewalls, and a car ceiling. A movable floor panel is located at the car floor. The movable floor panel is configured to be moved between a stowed position and a raised position, such that access to an elevator system hoistway is gained via the movable floor panel in the raised positon.

Additionally or alternatively, in this or other embodiments a scissor lift mechanism is operably connected to the movable floor panel to move the movable floor panel between the stowed position and the raised position.

Additionally or alternatively, in this or other embodiments an actuating mechanism is operably connected to the scissor lift mechanism to drive movement of the scissor lift mechanism.

Additionally or alternatively, in this or other embodiments movement of the movable floor panel between the stowed position and the raised position is controlled at a car operating panel of the elevator car.

Additionally or alternatively, in this or other embodiments a sensor is located at the car floor and is configured to detect when the movable floor panel is not in the stowed position.

Additionally or alternatively, in this or other embodiments a panel edge of the movable floor panel is set back a distance from the one or more car sidewalls.

Additionally or alternatively, in this or other embodiments a movable ceiling panel provides access to a hoistway area above the elevator car.

In another embodiment, an elevator system includes a hoistway, and an elevator car located in the hoistway and movable along the hoistway. The elevator car includes a car body having a car floor, one or more car sidewalls, and a car ceiling. A movable floor panel is located at the car floor. The movable floor panel is configured to be moved between a stowed position and a raised position, such that access to the hoistway is gained via the movable floor panel in the raised positon.

Additionally or alternatively, in this or other embodiments a scissor lift mechanism operably is connected to the movable floor panel to move the movable floor panel between the stowed position and the raised position.

Additionally or alternatively, in this or other embodiments an actuating mechanism is operably connected to the scissor lift mechanism to drive movement of the scissor lift mechanism.

Additionally or alternatively, in this or other embodiments movement of the movable floor panel between the stowed position and the raised position is controlled at a car operating panel of the elevator car.

Additionally or alternatively, in this or other embodiments a sensor is located at the car floor and is configured to detect when the movable floor panel is not in the stowed position.

Additionally or alternatively, in this or other embodiments the elevator car is immobilized along the hoistway when the sensor detects that the movable floor panel is not in the stowed position.

Additionally or alternatively, in this or other embodiments a panel edge of the movable floor panel is set back a distance from the one or more car sidewalls.

Additionally or alternatively, in this or other embodiments a movable ceiling panel provides access to a hoistway area above the elevator car.

In yet another embodiment, a method of performing maintenance on an elevator system component includes moving an elevator car along a hoistway to a maintenance position, raising a movable floor panel of the elevator car from a stowed position to a raised position, accessing an elevator system component located in the hoistway outside of the elevator car through an opening in the elevator car via the movable floor panel located in the raised position, and performing maintenance on the component from inside of the elevator car.

Additionally or alternatively, in this or other embodiments the movable floor panel is raised via a scissor lift mechanism operably connected to the movable floor panel.

Additionally or alternatively, in this or other embodiments the elevator car is immobilized along the hoistway when the movable floor platform is not in the stowed position.

Additionally or alternatively, in this or other embodiments a pit area of the hoistway below the elevator car is accessed from inside the elevator car when the movable floor panel is in the raised position.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of an elevator system;

FIG. 2 is a schematic illustration of an embodiment of an elevator car; and

FIG. 3 is another schematic illustration of an embodiment of an elevator car.

### DETAILED DESCRIPTION

A detailed description of one or more embodiments of the disclosed apparatus and method are presented herein by way of exemplification and not limitation with reference to the Figures.

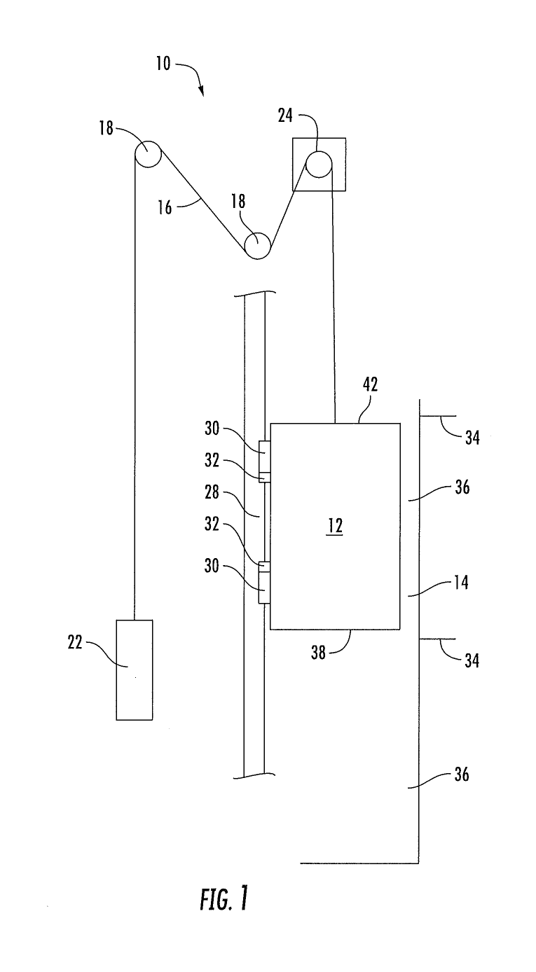

Shown in FIG. 1 is a schematic of an exemplary traction elevator system 10. The elevator system 10 includes an elevator car 12 operatively suspended or supported in a hoistway 14 with one or more suspension members 16, such as ropes or belts. The one or more suspension members 16 interact with one or more sheaves 18 to be routed around various components of the elevator system 10. The one or more sheaves 18 could also be connected to a counterweight 22, which is used to help balance the elevator system 10 and reduce the difference in suspension member 16 tension on both sides of a traction sheave 24 during operation.

The elevator system 10 further includes one or more guide rails 28 to guide the elevator car 12 along the hoistway 14. The elevator car 12 includes one or more guide shoes or rollers 30 interactive with the guide rails 28 to guide the elevator car 12. The elevator car 12 also may include safeties 32 interactive with the guide rail 28 to slow and/or stop motion of the elevator car 12 under certain conditions, such as an overspeed condition.

The hoistway 14 includes one or more landing floors 34 at which the elevator car 12 stops to allow ingress and/or egress of passengers from the elevator car 12 through elevator car doors (not shown). A landing floor door 36 is located at each landing floor 34 of the hoistway 14. During elevator system operation, the landing floor door 36 opens when the elevator car 12 is present at the landing floor 34 to allow for passenger ingress and/or egress.

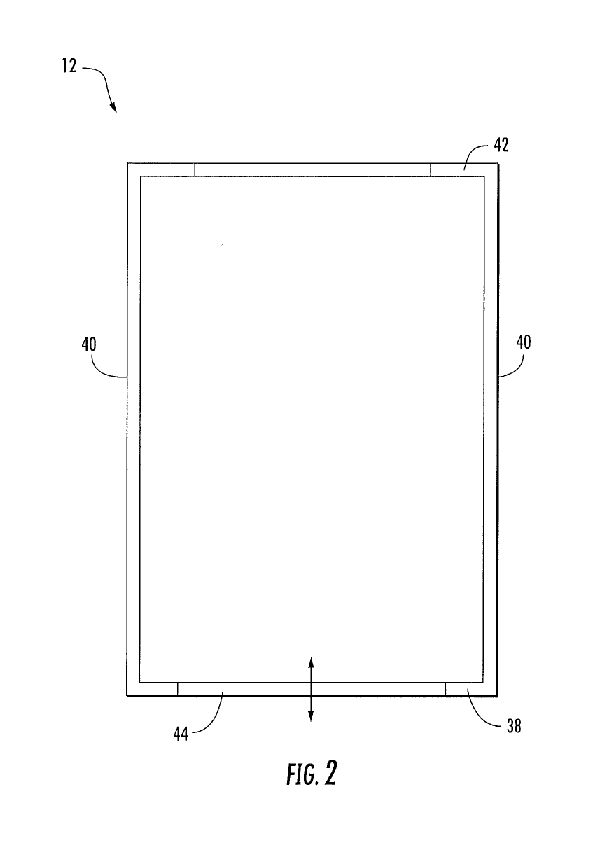

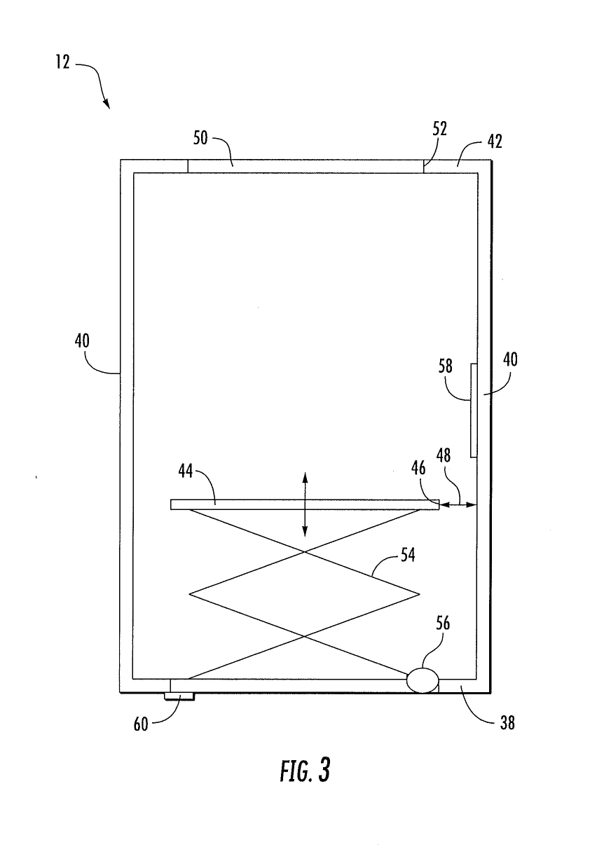

Referring now to FIG. 2, the elevator car 12 includes a car floor 38, car sidewalls 40 and a car ceiling 42. The car floor 38 includes a movable floor panel 44, movable between a stowed position such as shown in FIG. 2 and a raised position as shown in FIG. 3. When in the raised position, a technician on the movable floor panel 44 has access to components in the hoistway 14 such as suspension members 16, guide rails 28, guide shoes or rollers 30, or safeties 32, other mechanical or electrical components of the elevator system. This allows the technician to perform inspection or maintenance on such components while reaching from inside the elevator car 12, without climbing onto a roof of the elevator car 12 or otherwise entering the hoistway 14. Further, the raising of the floor panel 44 provides access to components below the elevator car 12, such as those located in a pit of the elevator system 10 at a bottom of the hoistway 14. By accessing the components in the pit via the elevator car 12, a need for items such as a pit ladder or pit light is reduced.

Referring to FIG. 3, the floor panel 44 has a panel edge 46 that is set back from the car sidewalls 40 an offset distance 48. This allows a technician access between the floor panel 44 and the sidewalls 40 when the floor panel 44 is in the raised position. In some embodiments, the offset distance is about 12 inches. Further, while in some embodiments, the offset distance 48 is constant around the panel edge 46, it is to be appreciated that the offset distance 48 may vary around the panel edge 46. Additionally, the car ceiling 42 is movable to allow access to the hoistway 14 via the elevator car 12 when the floor panel 44 is in the raised position. In some embodiments, the ceiling 42 includes a removable ceiling panel 50, while in other embodiments, such as shown, the ceiling panel 50 is movable via a ceiling hinge 52.

In some embodiments, such as shown, the floor panel 44 is movable via a scissor lift 54 operably connected to the car floor 38 and the floor panel 44. The scissor lift 54 may utilize a drive mechanism, such as an electromechanical actuator 56 to raise and/or lower the floor panel 44 relative to the car floor 38. It is to be appreciated, however, that in other embodiments the scissor lift 54 may be actuated by other mechanisms, such as a hand crank. Further, mechanisms other than the scissor lift 54 may be utilized to raise and/or lower the floor panel 44.

The electromechanical actuator 56 is connected to a car operating panel 58 of the elevator car 12 so the technician may raise and/or lower the floor panel 44 by activating switch or button, for example, on the car operating panel 58. It is to be appreciated that in other embodiments the electromechanical actuator 56 may be operated by other means. During times when the floor panel 44 is in the raised position, movement of the elevator car 12 along the hoistway 14 may be disabled. For example, a shutoff sensor 60 may be located at the floor panel 44 to detect when the floor panel 44 is in any position other than the stowed position. The shutoff sensor 60 is operably connected to the car operating panel 58 and/or an elevator system controller 62 so that the elevator car 12 cannot be driven along the hoistway 14 when the floor panel 44 is not in the stowed position.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An elevator car, comprising:
a car body, including:
a car floor;
one or more car sidewalls; and
a car ceiling; and
a movable floor panel disposed at the car floor, the movable floor panel configured to be moved between a stowed position and a raised position, such that access to an elevator system hoistway is gained via the movable floor panel in the raised positon.

2. The elevator car of claim 1, further comprising a scissor lift mechanism operably connected to the movable floor panel to move the movable floor panel between the stowed position and the raised position.

3. The elevator car of claim 2, further comprising an actuating mechanism operably connected to the scissor lift mechanism to drive movement of the scissor lift mechanism.

4. The elevator car of claim 1, wherein movement of the movable floor panel between the stowed position and the raised position is controlled at a car operating panel of the elevator car.

5. The elevator car of claim 1, further comprising a sensor disposed at the car floor configured to detect when the movable floor panel is not in the stowed position.

6. The elevator car of claim 1, wherein a panel edge of the movable floor panel is set back a distance from the one or more car sidewalls.

7. The elevator car of claim 1, further comprising a movable ceiling panel, to provide access to a hoistway area above the elevator car.

8. An elevator system, comprising:
a hoistway; and
an elevator car disposed in the hoistway and movable along the hoistway, the elevator car including:
a car body, including:
a car floor;
one or more car sidewalls; and
a car ceiling; and
a movable floor panel disposed at the car floor, the movable floor panel configured to be moved between a stowed position and a raised position, such that access to the hoistway is gained via the movable floor panel in the raised positon.

9. The elevator system of claim 8, further comprising a scissor lift mechanism operably connected to the movable floor panel to move the movable floor panel between the stowed position and the raised position.

10. The elevator system of claim 9, further comprising an actuating mechanism operably connected to the scissor lift mechanism to drive movement of the scissor lift mechanism.

11. The elevator system of claim 8, wherein movement of the movable floor panel between the stowed position and the raised position is controlled at a car operating panel of the elevator car.

12. The elevator system of claim 8, further comprising a sensor disposed at the car floor configured to detect when the movable floor panel is not in the stowed position.

13. The elevator system of claim 12, wherein the elevator car is immobilized along the hoistway when the sensor detects that the movable floor panel is not in the stowed position.

14. The elevator system of claim 8, wherein a panel edge of the movable floor panel is set back a distance from the one or more car sidewalls.

15. The elevator system of claim 8, further comprising a movable ceiling panel, to provide access to a hoistway area above the elevator car.

16. A method of performing maintenance on an elevator system component, comprising:
moving an elevator car along a hoistway to a maintenance position;
raising a movable floor panel of the elevator car from a stowed position to a raised position;
accessing an elevator system component located in the hoistway outside of the elevator car through an opening in the elevator car via the movable floor panel located in the raised position; and
performing maintenance on the component from inside of the elevator car.

17. The method of claim 16, further comprising raising the movable floor panel via a scissor lift mechanism operably connected to the movable floor panel.

18. The method of claim 16, further comprising immobilizing the elevator car along the hoistway when the movable floor platform is not in the stowed position.

19. The method of claim 16, further comprising accessing a pit area of the hoistway below the elevator car from inside the elevator car when the movable floor panel is in the raised position.
